(19) United States
(12) Patent Application Publication
(10) Pub. No.: US 2008/0264734 A1
(43) Pub. Date: Oct. 30, 2008

(54) COMBINATION WHEEL CHOCK AND BALLAST WEIGHT FOR MOTOR VEHICLES

(76) Inventor: Edward J. Walter, Sagamore Hills, OH (US)

Correspondence Address: D.A. STAUFFER PATENT SERVICES LLC, 1006 MONTFORD ROAD, CLEVLAND HTS., OH, 44121-2016, US

(21) Appl. No.: 11/739,780

(22) Filed: Apr. 25, 2007

(51) Int. Cl. B60T 3/00

(52) U.S. Cl. 188/32

(57) ABSTRACT

A container fillable with a flowable material such as sand, salt or water, and usable as a ballast weight for a back of a motor vehicle and also as a wheel chock. The container is elongate and may have a triangular cross section. One end may be permanently closed. An end cap at the other end may be removed for filling/emptying the container, or may have a hole sealed by a plug or a cap for filing/emptying the container. An anti-skid surface element may provided on an external surface of the body. A separate handle may be provided, or an integral handle may be provided. Stripes of a color contrasting with the body member may be disposed on at least two sides of the body member. The container may be formed of a rigid metal or plastic.

### TECHNICAL FIELD OF THE INVENTION

In one aspect, the present invention relates generally to wheel chocks. In another aspect, the invention relates to ballast containers to add weight for improved traction in motor vehicles.

### BACKGROUND OF THE INVENTION

Wheel chocks are used to prevent the wheels of a vehicle, such as an automotive vehicle or airplane, from moving. For example, a car or truck parked on a hill might move if the emergency brake is defective. Or, it is often good practice to immobilize the wheels of an automotive vehicle when working on it, particularly if jacking it up might defeat the immobilizing function of a parking brake. In the case of airplanes, chocks are often used to prevent a parked airplane from being moved by wind forces.

Adding ballast weight to an automotive vehicle to increase traction, particularly for winter driving, is well known.

U.S. Pat. No. 5,330,227 (“227 patent”) discloses storable truck bed weights for improved traction and handling. An apparatus for providing weight over the driven wheels of a motor vehicle. The apparatus includes a plurality of elongated containers for holding material. The material provides adjustable weight to the vehicle. The containers are installed on the floor of a normal cargo area of the vehicle. Also included are removable end covers located at one or both ends of the elongated containers for filling and emptying the containers with weighted material. A bracket is provided for holding the elongated containers with their installed end covers onto the floor of the vehicle to prevent movement of the containers with respect to the floor.

The elongated containers of the 227 patent are shown to be rectangular in cross section, and a plurality of containers are laid side-by-side to cover the bed of a pickup truck, and are bolted to the truck bed. Although the ends of the containers may be opened, it is not facile due to the bolted-in nature (more or less permanent installation) of the containers.

U.S. Pat. No. 2,992,704 (“704 patent”) discloses elongated wheel chocks comprising a light-weight material, such as aluminum, and anti-slip means. Each chock is a elongated hexagonal body having a relatively wide bottom surface (12) with respect to a relatively narrower top surface (13). The chocks are formed of elongated extruded half sections of material (18 and 19). Anti-slip means (47, 48, 50) molded from reclaimed rubber are disclosed.

The wheel chocks of the 704 patent are hollow, but do not appear to be practical for filling or emptying with a flowable material (such as sand or water).

U.S. Pat. No. 2,189,323 (“323 patent”) discloses automobile (or vehicle) wheel wedges (or “blocking” wedges) to be place against an automobile tire to prevent the wheels of the automobile from rolling when repairs are being made to the car, and particularly when one part of the car has been jacked up to allow a tire to be changed. The wedge is constructed in the form of a hollow box, triangular in longitudinal section, and preferably open at one triangular side. The three walls of the wedge are formed of a stiff material, such as sheet steel. Preferably, a pair of these open-sided box-like wedges are provide for use with an automobile.

The wheel wedge of the 323 patent has a hollow triangular shape, and a smaller wheel wedge may be inserted within another, slightly larger (in cross-section) wheel wedge. Although objects such as soap and rags may be stored inside, no means are disclosed in the 323 patent for filling with a flowable material. The wedges are open-sided, and thus cannot function as “containers”.

U.S. Pat. No. 6,681,901 (“901 patent”) discloses an aircraft tire chock comprising a triangular-shaped elongated body designed to fit against the surface of a tire on an aircraft. The body includes three longitudinally aligned support members. Disposed between the three support members is a plurality of triangular-shaped gussets, equally spaced apart and vertically aligned inside the body to support the support members. Aligned longitudinally between the support members are three, elongated replaceable bumpers that extend the full length of the elongated body between adjacent support members. Located over each end of the elongated body is an optional end cap. Formed inside each end cap and the end gussets is a centrally aligned bore. Disposed centrally through the bores in the end caps and the gussets is a short, longitudinally aligned pipe. Disposed inside the pipe is a short section of wire rope that is used as a pull handle to move or transport the chock. Reflective tape (90) or paint (92) may be applied to the outer surfaces to improve the chock's visibility at night.

The tire chock of the 901 patent is triangular, and hollow for lighter weight, but is not fillable with flowable material to increase its weight.

U.S. Pat. No. D298,823 (“823 patent”) discloses combined auto chock and container. The cross-section appears to be triangular (in the form of a right triangle). The longitudinal extent of the chock is shown as being less than its height (the height of the triangle), apparently corresponding to the tread width of a tire. Mention is made of a “rear door” (see description of FIG. 7) which appears to be hinged, but no latch is shown. (Apparently, the chock could be used for storing small items.)

The chock of the 823 patent appears to be useful for storing small items, but since no latch or sealing mechanism is apparent for the door (FIG. 7), it does not appear to be useful for filling with a flowable material. Furthermore, the chock appears to be only a few inches wide, such as would be appropriate for an automotive vehicle wheel chock. So, even if it were fillable, its short length would not allow for adding much weight (of a flowable material).

U.S. Pat. No. D283,317 (“317 patent”) discloses combined container and ramp for use in applying tire chains to vehicle tires. The “ramp” appears to serve as the lid of a picnic basket-like container, which could be removed to serve as a ramp, having two opposite inclined surfaces and a flat surface and a cutout therebetween, apparently for driving a tire of a vehicle up onto for aiding in applying a tire chain to the tire. Apparently, the tire chains could be stored in the container.

The container of the 317 patent does not appear to be “stackable”, meaning that a plurality of the apparatuses could be stacked neatly next to and atop one another. Nor does it appear the cover/ramp can be sealed onto the basket well enough to contain pourable material, especially liquids.

The chocks (and the tire ramp) disclosed in the patents discussed above appear to be generally lightweight, short (the width of a tire tread), and do not appear to be selectively fillable with a flowable material for increasing the weight of the apparatus. The chocks also do not appear to be suitable for stacking several of the chocks together.

### BRIEF SUMMARY OF THE INVENTION

It is a general object of the invention to provide an improved wheel chock which can also serve as a ballast weight for increasing traction when stored (for example) in the trunk or bed of a vehicle (particularly a rear-wheel drive vehicle), which can be stacked neatly with other similar chocks, and which can be selectively filled and emptied of a flowable material such as sand or water.

According to the invention, generally, apparatus and methods of use are described for providing extra weight for the rear of a vehicle when increased traction is desired, the apparatus also being usable as wheel chocks. (Or, vice-versa, a wheel chock that performs “double duty” as ballast weight for a vehicle.)

The apparatus (wheel chock) may be in the form of a tubular (hollow) container with sealed-on end caps, fillable with sand, dirt, salt, water, etc. One or more containers can be put in the trunk of a car, or on the bed of a pickup truck. One end of the container cap may have a screw-on closure (such as a cap) for a filling hole, and the closure cap may optionally be sealed with an O-ring. The cross-section of the container may be circular (pipe), rectangular (such as square, hollow strut), or triangular (including, but not limited to isosceles, equilateral). With a triangular shape, appropriate dimensions, and appropriate strength, the container is well-suited to be used as a wheel chock for preventing the vehicle from rolling.

In one embodiment, the container is in the form of a triangular cross-section hollow tube that is both fillable for ballast and designed for use as a wheel chock. The container is sealingly fillable with liquid (e.g., water) or granular flowing material (e.g., sand, salt), has an easily re-sealable filling-pouring opening (e.g., a screw-on cap), and has a stackable shape that won't roll

In one embodiment, the container has an easily re-sealable filling-pouring opening (such as a screw-on cap). Thus another use for the apparatus is to serve as a container for grit (e.g., sand) and ice melter (e.g., rock salt) which can be poured out on a slippery/icy driving surface to aid traction for the vehicle.

A container having a circular cross-section may not be optimal for use as a wheel chock, since there may be minimal “footprint” with a road surface. In contrast thereto, a container having at least one flat surface is considered to be more optimal, the entire flat surface being in contact with the road. An anti-skid resilient material, such as rubber, may be provided on the flat, road-contacting surface of the container.

In some forms (such as rectangular, triangular), multiple containers may be readily and compactly (efficient use of space) stacked up, to provide a selected amount of extra weight for traction. And, when stacked side-by-side, resulting in a substantially uninterrupted flat surface.

Generally, the non-round shapes (such as rectangular, triangular) also prevent rolling around of the containers in the rear of the vehicle.

The container(s) may be provided with reflective (light-reflecting) warning-strip tape, or be painted with stripes.

The container(s) may be provided with strap(s) to provide a handle. The container(s) may be provided with a molded-in handle (for example, in the form of an opening passing through two adjacent sides of a triangular shaped container near the vertex of the triangle).

According to the invention, an elongate container having a hollow body functions as a combination wheel chock and ballast weight for motor vehicles. The hollow body can be filled with a flowable material, such as sand or water. Generally, a back end of the hollow body is permanently closed, and the front end can be opened for filling or emptying the container of the flowable material. An end cap for the front end can be removable to permit such filling/emptying. Alternately, the front end cap can be fixed to the front end of the body, and have a hole extending therethrough which can be closed and sealed with a cooperating/mating plug or cap. An O-ring may be provided to ensure water-tightness.

The container may have various cross-sections. A triangular cross-section is particularly useful.

An advantage of a triangular construction is that it has at least one flat surface. An anti-skid surface element may provided on an external surface of the body to help keep the container in place when it being used as a wheel chock.

Another advantage of a triangular construction is that a plurality of containers can be stacked, such as side-by-side, every other one being positioned upside-down, fitting closely with one another, resulting in a flat, uninterrupted surface. This is useful for putting a plurality of triangular containers in the bed of a pickup truck.

Stripes of a color contrasting with the body member may be disposed on at least two sides of the body member.

The body is formed of a rigid material selected from the group consisting of metal and plastic.

A separate handle may be provided to assist a user in lifting, carrying and otherwise handling the container. Alternatively, an opening may be disposed in the body, approximately midway along the length of the body, sized to function as an integral handle which can be conveniently grasped by a user inserting four fingers through the opening.

The container may have the following dimensions:
the length (A) of the body is 9-90 inches (22-225 cm); and
the height (B) of the body is 2-8 inches (5-20 cm).

The container may be sized and shaped to function well as a wheel chock for a normal size passenger car or small truck tire.

The container may be sized to hold at least 5 pounds and up to 50 pounds of water, as ballast.

Generally, in use as a tail weight, several of the containers may be used to add weight to the rear of a vehicle, to obtain better traction in winter driving conditions. Tail weight configurations serve the purpose of added weight and the ability to be filled with sand, ice melt, or any material that will add weight to the container. The tail weight containers are able to dispense stored material if needed, to be applied to the surface under the vehicle tires for better traction.

Reflective tape may be applied to the exterior of the containers for the purpose of an emergency stop. The container can be placed strategically behind the vehicle to alert oncoming traffic. (However, it should be noted that local laws vary, and the container may not be a legal substitute for a required reflective triangle.)

Various configurations for the container are disclosed, such as square and triangular, which can also be used as wheel chocks (especially the triangular container) which will fit well by a tire.

The triangular container also interlocks (stacks/nests) well with other triangular containers when three or more are needed.

The filling of the container(s) with a flowable material such as sand or water is intended for the function as ballast (dead weight) and/or as a driving surface treatment. Although the container(s) could also be filled with drinking water or gasoline, these uses are not recommended, for health and safety reasons, respectively.

Other objects, features and advantages of the invention will become apparent in light of the following description thereof.

### BRIEF DESCRIPTION OF THE DRAWINGS

Reference will be made in detail to preferred embodiments of the invention, examples of which are illustrated in the accompanying drawing figures (FIGS.). The figures are intended to be illustrative, not limiting. Although the invention is generally described in the context of these preferred embodiments, it should be understood that it is not intended to limit the spirit and scope of the invention to these particular embodiments.

Certain elements in selected ones of the drawings may be illustrated not-to-scale, for illustrative clarity. The cross-sectional views, if any, presented herein may be in the form of “slices”, or “near-sighted” cross-sectional views, omitting certain background lines which would otherwise be visible in a true cross-sectional view, for illustrative clarity.

Elements of the figures can be numbered such that similar (including identical) elements may be referred to with similar numbers in a single drawing. For example, each of a plurality of elements collectively referred to as 199 may be referred to individually as 199a, 199b, 199c, etc. Or, related but modified elements may have the same number but are distinguished by primes. For example, 109, 109′, and 109″ are three different elements which are similar or related in some way, but have significant modifications. Such relationships, if any, between similar elements in the same or different figures may become apparent throughout the various descriptions thereof set forth herein.

The structure, operation, and advantages of various embodiments of the invention will become further apparent upon consideration of the following description taken in conjunction with the accompanying drawings.

FIG. 1 is a schematic illustration, exploded, of a general (generic) embodiment of a combination wheel chock and ballast weight for motor vehicles (“container”), according to the invention.

FIG. 2A is an exploded, side view of an embodiment of an end of a container, according to the invention.

FIG. 2B is an exploded, side view of an embodiment of an end of a container, according to the invention.

FIG. 2C is an exploded, side view of an embodiment of a closure member for an end of a container, according to the invention.

FIG. 2D is an exploded, side view of an embodiment of a closure member for an end of a container, according to the invention.

FIG. 3A is an end view of an embodiment of a closure member for an end of a container, according to the invention.

FIG. 3B is an end view of an embodiment of a closure member for an end of a container, according to the invention.

FIG. 3C is an end view of an embodiment of a closure member for an end of a container, according to the invention.

FIG. 4A is a side view of an embodiment of a container, according to the invention.

FIG. 4B is a top view of the embodiment of a container shown in FIG. 4A.

FIG. 5A is an end view of a plurality of containers disposed in the bed of a pickup truck, according to the invention.

FIG. 5B is a side view of a container being used as a wheel chock, according to the invention.

### DETAILED DESCRIPTION OF THE INVENTION

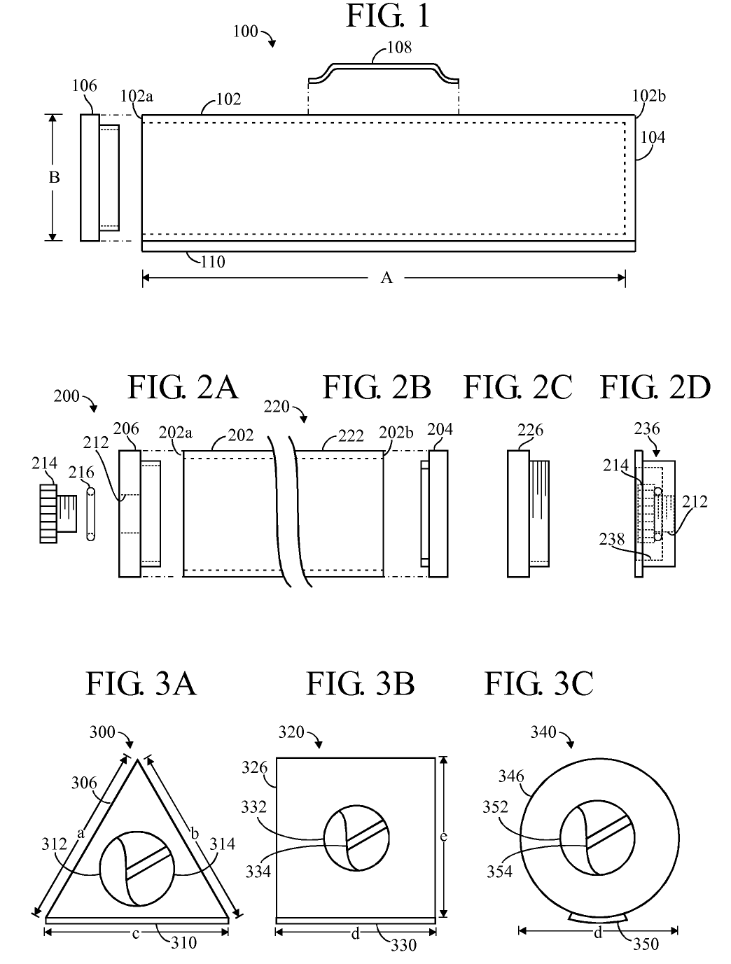

FIG. 1 illustrates an embodiment of a combination wheel chock and ballast weight 100 for motor vehicles. The apparatus 100 is essentially a container comprising elongate tubular body 102, having two opposite ends—a front end 102a and a back end 102b, a length “A”, and a height “B”. (Please note that FIG. 1 is a schematic illustration, and nothing limiting about the cross section of the body should be implied, inferred, or concluded from this drawing.) The body 102 is hollow, so that it can be filled with a flowable material (not shown) such as a liquid (such as water), or a particulate solid (such as sand or salt particles). The body may 102 may be formed of metal, or of plastic.

The back end 102b of the container 100 is shown as being closed, as indicated by the wall 104. The front end 102a of the container 100 is shown as being open.

A separate closure member (end cap) 106 is adapted to close the front end 102a of the container 100 so that flowable material may be retained within the container 100. The closure member 106 may be removable, for filling the container 100 with flowable material, as well as for emptying the container of flowable material. Various embodiments of end caps are disclosed hereinbelow.

A separate handle 108 may be provided, and may be fixably attached to, temporarily secured to, and/or detachable from the body 102. The purpose of the handle 108 is to assist a user in lifting, carrying and otherwise handling the container 100. Alternatively, a separate strap can be secured around one or more containers to form a handle for easy carrying and picking up of the containers.

An anti-skid surface element 110, such as a strip of rubber (or any resilient material), may be provided on an external surface of the body 102. The purpose of the anti-skid surface element 110 is to help keep the container in place when it being used as a wheel chock. In another example, the anti-skid surface element 110 could be a rough surface (e.g., grit glued on).

The body 102 of the container 100 may have various cross sections, such as triangular, rectangular, and round as illustrated in FIGS. 3A, 3B and 3C, discussed hereinbelow.

The body 102 may be formed of a rigid material such as metal or plastic, and can be formed, extruded, or molded, or assembled from individual pieces which are welded or glued together.

FIG. 2A illustrates an alternate embodiment for the front end 202a (compare 102a) of a body member 202 (compare 102) of a container 200 (compare 100). In this embodiment, the closure member 206 has a hole 212 extending therethrough. The hole 212 may be threaded, to matingly receive a threaded plug 214. The closure member 206 may be permanently affixed to the body member 202.

For filling or emptying the container 200 of flowable material, the plug 214 would be removed, thereby revealing the hole 212. With the plug 214 in place, the hole 212 is sealed so that the flowable material is retained within the body 202 of the container 200. An O-ring 216 may be provided to ensure a good seal between the plug 214 and the closure member (end cap) 206.

Alternatively, the closure member could have a threaded projection instead of a threaded hole (212), and the plug (214) would be more like a screw-on bottle cap. FIG. 2A is illustrative of the concept that a suitable means can be provided for gaining access to the otherwise sealed interior of the hollow body with any suitable means such as a hole in the end cap and a mating plug fitting securely into the hole, or a threaded projection from the end cap and a threaded cup shaped cap closing off the projection. Whether a cap or a plug, the instrumentality sealing the filling/emptying hole in the end cap should be easily installed (such as by threading, or a quarter turn mechanism, or a secure snap fit) and seal (if necessary, with the assistance of the O-ring) the flowable material within the hollow body of the container.

FIG. 2B illustrates an alternate embodiment for the back end 202b (compare 102b) of a body member 222 (compare 102) of a container 220 (compare 1 00). In this embodiment, a separate wall element 204 (compare 104) closes the back end 202b of the body 220. The back end cap 204 is fixed in any suitable manner to the back end 202b of the body 220. If the body member 222 and the back end cap 204 are both plastic, the end cap could be glued to the body member. If the body member 222 and the back end cap 204 are both metal, the end cap could be welded to the body member.

FIG. 2C illustrates an alternate embodiment for an end cap being a releasably closing end cap 226 (compare 106) for the front end 202a (compare 102a) of a body member 202 (compare 102) of a container 200 (compare 100). In this embodiment, the body member would be round (see, for example, FIG. 3C), and would be threaded to receive the end cap 226, which has mating threads so that the end cap could be selectively installed on and removed from the front end 202a of the body member, thereby releasably closing the container 200.

FIG. 2D illustrates an alternate embodiment for an end cap being a releasably closing end cap 236 (compare 206) for the front end 202a (compare 102a) of a body member 202 (compare 102) of a container 200 (compare 100). In this embodiment, the closure member 236 has a hole 212 extending therethrough. The hole 212 may be threaded, to matingly receive a threaded plug 214. The closure member 236 may be permanently affixed to the body member 202. In these aspects just described, the alternate closure member 236 is substantially the same as the closure member 206. The aspect that distinguishes the alternate closure member 236 is a recess 238 that sets back the plug 214 such that it is protected from damage by objects such as other containers 200 that could be dropped on it or jostled against it as multiple wheel chock/ballast weights are piled in a vehicle. Also, such use of a recess 238 to protectively receive the plug 214 helps prevent the plug 214 from catching on other objects.

As mentioned above, the body 102 of the container 100 may have various cross sections, such as triangular, rectangular and round. Generally, the overall shape of the end cap 106, 206, is dictated by the cross-section of the body 102, 202 of the container. For example, a triangular container would have a triangular end cap, a square container would have a square end cap, and a round container would have a round end cap. In the case of non-round containers 100, 200, the end cap 106, 206 could be made as a releasably closing end cap 226 by using, for example, a snap-fit ridge and groove combination, one of the combination being on the end cap 226 (e.g., a ridge) and the corresponding/mating other (e.g., groove) inside the front end 202a.

FIG. 3A illustrates an end cap 306 (compare 206) for a container 300 (such as 100) having three sides and a triangular cross section, thus the end cap 306 is triangular and has three sides. The three sides of the triangular end cap 306 have dimensions (lengths) “a”, “b” and “c”. If a=b, the triangle is isosceles. If a=b=c, the triangular is equilateral. The triangle may be a right triangle. The triangle may be any triangle. (Nothing limiting about the dimensions or type of the triangle should be inferred from the drawing showing what appears to be an equilateral triangle.)

The body (compare 102) is not visible in this end view. However, an anti-skid surface element 310 (compare 110) applied to one of the sides of the body 102 is visible. Here, the anti-skid surface element 310 is shown disposed on the side having dimension “c”.

The end cap 306 may have a hole 312 (compare 212) extending therethrough, which is closeable by a plug 314 (compare 214), for selectively filling the container with flowable material, retaining the flowable material within the container, or dispensing flowable material from the container. The plug 314 is shown partially broken away to reveal the hole 312.

FIG. 3B illustrates an end cap 326 (compare 306) for a container 320 (such as 100) having four sides and a rectangular cross section, thus the end cap 326 is rectangular and has four sides. A rectangle has two dimensions, the base “d” and height “e”. If “d”=“e”, the rectangle is a square. Other four sided geometries such as rhombus, parallelogram and trapezoid are deemed to be within the scope of the invention. (Nothing limiting about the dimensions or type of the four-sided geometry should be inferred from the drawing showing what appears to be a square.) (It should also be noted that a trapezoid could be generated by cutting the top off of a triangle.)

The body (compare 102) is not visible in this end view. However, an anti-skid surface element 330 (compare 310) applied to one of the sides of the body 102 is visible. Here, the anti-skid surface element 330 is shown disposed on the side having dimension “d”.

The end cap 326 may have a hole 332 (compare 312) extending therethrough, which is closeable by a plug 334 (compare 314), for selectively filling the container with flowable material, retaining the flowable material within the container, or dispensing flowable material from the container. The plug 334 is shown partially broken away to reveal the hole 332.

FIG. 3C illustrates an end cap 346 (compare 326) for a container 340 (such as 100) having a round, such as circular cross section, thus the end cap 346 is round (such as circular). A circle has one critical (defining) dimension, its radius or diameter. Here, the diameter is labeled “f”.

The body (compare 102) is not visible in this end view. However, an anti-skid surface element 350 (compare 330) applied to a portion of the external surface of the body 102 is visible. Here, the anti-skid surface element 350 is shown extending approximately 10-30 degrees around the circumference of the circle.

Alternatively, a portion of the external surface of the body member could be flattened, so that the container can remain in place (without rolling around) when laying on a flat surface, and the anti-skid element would be applied to the flat surface.

The end cap 346 may have a hole 352 (compare 332) extending therethrough, which is closeable by a plug 354 (compare 334), for selectively filling the container with flowable material, retaining the flowable material within the container, or dispensing flowable material from the container. The plug 354 is shown partially broken away to reveal the hole 352.

It is generally preferred that there be at least one flat surface for the body member 102 of the container, whereupon the anti-skid element 110 would be applied. Geometries having more than four sides, such as pentagon and hexagon are also deemed to be within the scope of the invention. Other geometries, particularly those having at least one flat side, such as semi-circular are also acceptable. The schematic representation of FIG. 1 is non-limiting with regard to the cross-sectional geometry of the body member of the container. Generally, the shape of the end cap (see FIGS. 3A, 3B, 3C) is representative of the cross-section of the body member.

As is exemplary of all the plugs (214, 314, 334, 354) discussed herein, the plug 314 may screw into the corresponding hole (212, 312, 332, 352) in the end cap, or may be locked therein with a quarter turn, “bayonet mount” type mating arrangement between plug and hole. Or, it may be a snap fit. (Also, the plug may be a cap, as discussed above.) Any means for releasably retaining the plug(s) in place in the end cap so as to seal the flowable material within the container are deemed to be acceptable, and within the scope of the invention. The plugs (214, 314, 334, 354) should be operable (able to be mounted and dismounted from the respective end cap) by hand, without the aid of tools, and may have knurled surfaces, or ridges incorporated therein, to aid in manual operability.

The end cap 226 (FIG. 2C) may similarly also be interlocked in any suitable manner to the body member 102 to releasably close the container.

Exemplary values for the dimensions set forth above are:
A, the length of the body (FIG. 1), 9-90 inches (22-225 cm)
B, the height of the body (FIG. 1), 2-8 inches (5-20 cm)
a, one side of the triangle (FIG. 3A), 2-6 inches (5-15 cm)
b, another side of the triangle (FIG. 3A), 2-6 inches (5-15 cm)
c, another side of the triangle (FIG. 3A), 2-6 inches (5-15 cm)
d, one side of the rectangle (FIG. 3B), 2-8 inches (5-20 cm)
e, another side of the rectangle (FIG. 3B), 2-8 inches (5-20 cm)
f, diameter of the circle (FIG. 3C), 2-10 inches (5-25 cm)

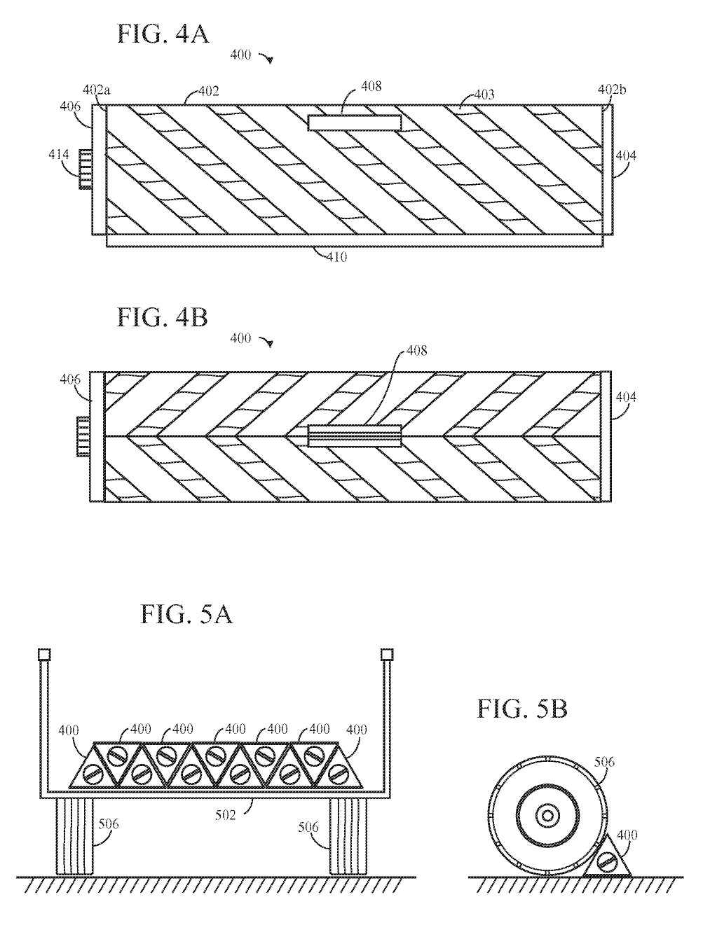

FIGS. 4A and 4B illustrate a triangular cross-section container 400, such as has been discussed hereinabove (FIG. 3A). The container 400 (compare 300) comprises a hollow, tubular body 402 (compare 102) having a front end 402a (compare 102a) and a back end 402b (compare 102b), a back end wall or closure member 404 (compare 104 or 204), a front end cap 406 (compare 106, 306), and a plug 414 (compare 314) sealing a hole (compare 312) in the front end cap 406.

An anti-skid element 410 (compare 310) is disposed on one of the three flat, elongate sides of the container 400, here shown as the bottom, road-contacting surface.

Stripes 403 of a color contrasting with the remainder of the body member 402 are disposed on the remaining two exposed flat, elongate sides of the body member 402. For example, the body member may be yellow or white (plastic), and the stripes 403 may be red or black. The stripes 403 may be painted on, or be applied as tape, and may be reflective (light-reflecting.). The striped container can serve as an emergency (hazard) marker (indicator) when deployed, for example, behind a vehicle stopped for repair on the side of the road.

An opening 408 is disposed in the body 402, approximately midway along the length of the body 402, near the vertex of the two striped sides of the triangular body 402, and is sized to function as an integral handle (compare 108) which can be conveniently grasped by a user inserting four fingers through the opening and his/her thumb around the apex. For example, the opening extends 4-6 inches (10-15 cm) in the longitudinal (dimension “A”) direction, and is 1-1½ inches (2.5-4 cm) wide (vertical, as illustrated).

FIG. 5A illustrates a plurality of containers, such as the triangular cross-section container 400, disposed in a bed 502 of a pickup truck. This is a view from the rear, with the tailgate down (or removed). To lend perspective, two tires 506 are shown.

A feature being illustrated is that a plurality of containers can be neatly and compactly stacked, side-by-side. In this example, every other container is inverted (upside down), and a “layer” of such containers has a substantially flat and uninterrupted bottom surface (against the bed 502) as well as a substantially flat and uninterrupted top surface which is substantially parallel to the bottom surface.

As mentioned above, the length “A” of the container (FIG. 1) is suitably 9-90 inches (22-225 cm). Generally, the longer the better, since volume will increase linearly with length (for a given cross-section), and weight will increase linearly with volume (for a given fill material).

As mentioned above, the height “B” of the container (FIG. 1) is suitably, 2-8 inches (5-20 cm). For purposes of ballast, the higher the better. But, as can be seen, the containers encroach on the usable volume of the truck bed, so a “conservative” height of 4-6 inches (10-15 cm) may be most suitable.

With a length of 80 inches (200 cm) and a height of 5 inches (12 cm), the volume of a single container having a cross-section which is an equilateral triangle would be approximately 1800 cm³, or 18 liters. 18 liters of water weighs approximately 18 kg, which is approximately 40 pounds. Generally, the container should be sized to as to hold at least 5 pounds (2 kilograms) of water, and up to approximately 50 pounds (20 kilograms) of water, as ballast.

FIG. 5B illustrates a container, such as the triangular cross-section container 400, being used as a chock to prevent a wheel 506 of the truck from rolling. For this purpose, the container is sized and shaped to function well as a wheel chock for a normal size passenger car or small truck tire. For example, the height “B” of the container is 4-6 inches (10-15 cm), and the triangular shape is well suited to the purpose.

Although the invention has been illustrated and described in detail in the drawings and foregoing description, the same is to be considered as illustrative and not restrictive in character—it being understood that only preferred embodiments have been shown and described, and that all changes and modifications that come within the spirit of the invention are desired to be protected. Undoubtedly, many other “variations” on the “themes” set forth hereinabove will occur to one having ordinary skill in the art to which the present invention most nearly pertains, and such variations are intended to be within the scope of the invention, as disclosed herein.

What is claimed is:

1. A combination wheel chock and ballast weight for motor vehicles comprising:
a container comprising an elongate body having a front end and a back end, having a length (A) and having a height (B), wherein the body is hollow so that it can be filled with a flowable material, wherein the back end is closed, and wherein the front end is open;
an end cap releasably closing the front end of the container for selectively filling and emptying the flowable material; and
a size and shape of the container suitable to function as a wheel chock for a normal size passenger or small truck tire.

2. The apparatus of claim 1, wherein the body of the container has a triangular cross section.

3. The apparatus of claim 2, wherein the releasably closing end cap comprises a hole extending through the end cap and a plug for selectively revealing and sealing the hole.

4. The apparatus of claim 3, further comprising a handle to assist a user in lifting, carrying and otherwise handling the container.

5. The apparatus of claim 3, further comprising stripes of a color contrasting with the body member, and disposed on at least two sides of the body member.

6. The apparatus of claim 1, wherein the releasably closing end cap comprises:
a hole extending through the end cap and a plug for revealing and sealing the hole.

7. The apparatus of claim 6, further comprising an O-ring seal between the plug and the end cap.

8. The apparatus of claim 6, further comprising a recess in the end cap for protectively receiving the plug.

9. The apparatus of claim 1 further comprising an anti-skid surface element provided on an external surface of the body to help keep the container in place when it being used as a wheel chock.

10. The apparatus of claim 9 wherein the anti-skid surface element comprises a strip of resilient material.

11. The apparatus of claim 1, wherein the front end of the body is threaded, and the end cap has mating threads.

12. The apparatus of claim 1, further comprising stripes of a color contrasting with the body member, and disposed on at least two sides of the body member.

13. The apparatus of claim 12, wherein the stripes are light reflecting.

14. The apparatus of claim 1, wherein the flowable material is selected from the group consisting of a liquid and a particulate solid, the liquid comprises water, and the particulate solid is selected from the group consisting of sand and salt.

15. The apparatus of claim 1, wherein the body is formed of a rigid material selected from the group consisting of metal and plastic.

16. The apparatus of claim 1, wherein the back end comprises a separate wall element.

17. The apparatus of claim 1, wherein the body comprises at least one flat surface.

18. The apparatus of claim 1, wherein:
the length (A) of the body is 9-90 inches (22-225 cm); and
the height (B) of the body is 2-8 inches (5-20 cm).

19. The apparatus of claim 1, further comprising a handle to assist a user in lifting, carrying and otherwise handling the container.

20. The apparatus of claim 19, further comprising:
an opening disposed in the body, approximately midway along the length of the body, sized to function as an integral handle which can be conveniently grasped by a user inserting four fingers through the opening.
